(19) United States
(12) Patent Application Publication
(10) Pub. No.: US 2016/0287984 A1
(43) Pub. Date: Oct. 6, 2016

(54) ADAPTIVE GAME FOR MOBILE DEVICES AND METHODS FOR GENERATING CUSTOMIZED GAMING CONTENT

(71) Applicant: TrivNow, LLC, Atlanta, GA (US)

(72) Inventors: Salvatore A. Principato, Sandy Springs, GA (US); Jamil A. Voss, Sandy Springs, GA (US); Anthony F. Principato, Sandy Springs, GA (US)

(21) Appl. No.: 14/718,890

(22) Filed: May 21, 2015

Related U.S. Application Data
(60) Provisional application No. 62/141,397, filed on Apr. 1, 2015.

(51) Int. Cl. A63F 13/216; A63F 13/215

(52) U.S. Cl. CPC A63F 13/216; A63F 13/215

(57) ABSTRACT

Methods, systems, and apparatus, including computer programs encoded on a computer storage medium, for an adaptive multiplayer game and generating customized gaming content for the same.

### CROSS-REFERENCE TO RELATED APPLICATIONS

This application claims priority to U.S. Provisional Application No. 62/141,397 filed Apr. 1, 2015, which are hereby incorporated herein in their entireties by reference.

### BACKGROUND

The Internet provides access to a wide variety of resources. For example, video and/or audio files, as well as web pages for particular subjects or particular news articles are accessible over the Internet. The Internet connects millions of mobile user devices to the resources above and to one another.

Streaming is a type of delivery for media files using the Internet, where the media files are being constantly received by and presented to an end-user while being simultaneously delivered by a provider hosting the media files. For example, audio/visual files (e.g., MPEGs, MP3s, and WMVs) may be streamed by users. Streaming allows user devices to begin playing a media file prior to receiving the entire media file.

Mobile devices enable users to make and receive phone calls, send and receive e-mails, browse and search the web, and send and receive text. Mobile devices also enable users to stream multimedia files and play offline and online games with friends or strangers from any location.

Online multiplayer games are typically played across multiple devices in different locations. Such games may associate a particular user with a device using an ID, and enable communication between user devices in a same gaming session. As mobile devices and Internet technologies advance, multiplayer mobile gaming is becoming more accessible than ever. These technologies provide means for connecting millions of users across the globe with one another in different games of luck and skill.

### SUMMARY

In general, embodiments of the present invention provide methods, apparatus, systems, computing devices, computing entities, and/or the like for generating custom content for an adaptive game.

In general, one innovative aspect of the subject matter described herein can be embodied in methods that include the actions of receiving input, from a first user, indicative of an initiation of customized audio/visual content creation, providing the received input to a first audio/visual service hosting a plurality of audio/visual content, receiving search results indicative of one or more videos having audio/visual content responsive to the received input, in response to receiving a selection of a particular search result, stream a video linked to the particular search result from the audio/visual service, receiving a selection of a first timing mark and a second timing mark for the video, and providing information/data that causes user devices of users different from the first user to stream, from the audio/visual service, a video loop of the video between the first timing mark and the second timing mark, in response to selection of the customized audio/visual content.

Other embodiments of this aspect include corresponding systems, apparatus, and computer programs, configured to perform the actions of the methods, encoded on computer storage devices.

These and other embodiments can each optionally include one or more of the following features. The methods can further include providing the received input to a first factual informational service, receiving search results indicative of one or more webpages having factual information/data related to the customized audio/visual content and responsive to the received input, and in response to receiving a selection of a particular search result, storing a link to a one or more webpages linked to the particular search result. The methods may further include providing information/data that causes user devices of users different from the first user to display a link to the factual webpage with the customized audio/visual content, in response to selection of the customized audio/visual content.

In general, another aspect of the subject matter described herein can be embodied in methods that include the actions of receiving input, from a first user, indicative of user interest in a first television program, receiving a first real-time information/data indicative of a beginning of a commercial break during the first television program; and in response to receiving the first real-time data, providing during the commercial break, to a mobile user device of the first user, content related to the first television program.

Other embodiments of this aspect include corresponding systems, apparatus, and computer programs, configured to perform the actions of the methods, encoded on computer storage devices.

These and other embodiments can each optionally include one or more of the following features. The methods can further include receiving a second real-time information/data indicative of an ending of the commercial break during the first television program, and in response to receiving the second real-time data, halting the providing of content to the mobile user device.

In general, another aspect of the subject matter described herein can be embodied in methods that include the actions of determining a geofence around a host device, based on information/data associated with the host device; and identifying first devices within the geofence, and in response, allow the first devices to join a game hosted by the host device, identifying second devices outside the geofence, and in response not allow the second devices to join the game hosted by the host device, determining that a device from the first devices moved outside the geofence, and in response, prompt the host device to disconnect the device from the first devices. Other embodiments of this aspect include corresponding systems, apparatus, and computer programs, configured to perform the actions of the methods, encoded on computer storage devices.

Particular embodiments of the subject matter described herein can be implemented so as to realize one or more of the following advantages. Enabling users and hosts to use mobile devices to host and participate in live multiplayer gaming events. Geofences can be employed to facilitate live game management. The price associated with hosting multiplayer gaming events is reduced, increasing the accessibility of entertainment for any establishment. Hosting and participating in online gaming events only requires mobile devices, eliminating the need for gaming and hosting equipment. Users can utilize widely available audio/visual and informational resources to create custom content for sharing with other users. The customized content may be directly streamed from an audio/visual hosting service. Users can subscribe to particular television live programming and enjoy a synchronized gaming experience during commercial breaks.

The details of one or more embodiments of the subject matter described herein are set forth in the accompanying drawings and the description below. Other features, aspects, and advantages of the subject matter will become apparent from the description, the drawings, and the claims.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an example environment in which an online adaptive multiplayer game is played and hosted on a plurality of user devices and customized gaming contents are generated.

FIG. 2A is an example environment in which a multiplayer game is hosted by a user device having a customizable geofence.

FIG. 2B is a flow chart of an example process for hosting a multiplayer game having a customizable geofence.

FIG. 3 depicts a mobile device using video looping stream to generate customized gaming content for an online adaptive multiplayer game.

FIG. 4A is a flow chart of an example process for generating customized audio/visual gaming content for an online adaptive multiplayer game.

FIG. 4B is a flow chart of an example process for generating customized factual validation gaming content for an online adaptive multiplayer game.

FIG. 5A and FIG. 5B depict a mobile device using an interface for an online adaptive multiplayer game.

FIG. 6 is a flow chart of an example process for distributing customized audio/visual content for an online adaptive multiplayer game.

FIG. 7 is a flow chart of an example process for providing gaming content to user devices during commercial breaks based on real-time data.

FIG. 8 is block diagram of an example computer system that can be used to create and/or distribute customized audio/visual content.

Like reference numbers and designations in the various drawings indicate like elements.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The description that follows describes methods and systems for an adaptive multiplayer game for mobile devices and for generating customized gaming content for the same. In some implementations, the adaptive multiplayer game for mobile devices is a trivia game. The multiplayer game may have multiple modes of operation. For example, the multiplayer game may be played live by a group of user devices within a particular distance from a hosting device. In some implementations, the multiplayer game includes a single player mode, where a player may answer one or more trivia questions during a gaming session and receives a score at the end of the session. Alternatively, the game may be played online with other players having devices that are connected to the Internet. The details of the game modes of operation are discussed below, in more detail.

### II. Example Operating Environment

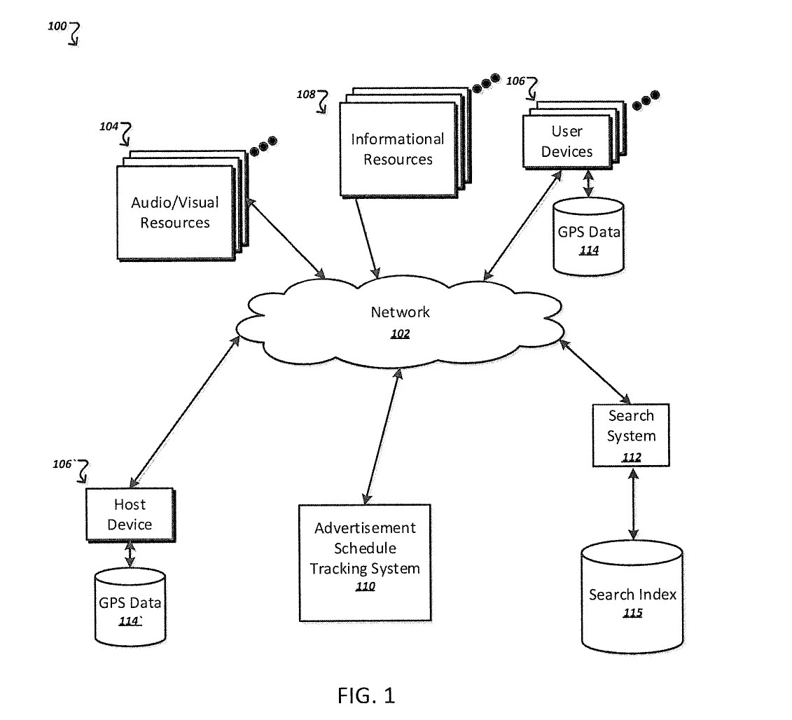

FIG. 1 is a block diagram of an example environment 100 in which an online adaptive game is played and hosted on a user device and customized gaming contents are generated. For example, the environment 100 includes a plurality of user devices 106 and 106′ for playing and hosting online adaptive multiplayer games. The example environment 100 also includes a network 102, such as a local area network (LAN), a wide area network (WAN), the Internet, or a combination thereof. The network 102 connects audio/visual resources 104, informational resources 108, user devices 106 and 106′, advertisement schedule tracking system 110, and the search system 112. The example environment 100 may include many thousands of informational and audio/visual resources 104 and 108, and user devices 106 and 106′.

Audio/visual and informational resources 104 and 108 are associated with domain names and hosted by one or more servers. For example, a website may comprise one or more audio/visual resources 104 hosted by one or more servers. A website may also comprise one or more informational resources 108 hosted by one or more servers. Still a website may be a combination of informational and audio/visual resources hosted by one or more servers. An example website is a collection of web pages formatted in hypertext markup language (HTML) that can contain text, images, multimedia content, and programming elements, such as scripts. Each website is maintained by a publisher, which is an entity that controls, manages and/or owns the website.

A resource is any information/data that can be provided over the network 102. A resource is identified by a resource address that is associated with the resource. Resources include HTML pages, word processing documents, and portable document format (PDF) documents, images, video, and feed sources, to name only a few. The resources can include content, such as words, phrases, images and sounds, that may include embedded information/data (such as meta-information in hyperlinks) and/or embedded instructions (such as JavaScript scripts).

A user device 106 or 106′ is an electronic device that is under control of a user and is capable of requesting and receiving resources over the network 102. Example user devices 106 and 106′ include personal computers, mobile communication devices, and other devices that can send and receive information/data over the network 102. A user device 106 typically includes a user application, such as a web browser, to facilitate the sending and receiving of information/data over the network 102.

A user device 106 can request audio/visual resources 104 and informational resources 108 from websites. In turn, information/data representing these resources can be provided to the user device 106 for presentation by the user device 106. The information/data representing the resources can also include information/data specifying a portion of the resource or a portion of a user display (e.g., a presentation location of a pop-up window or in a specified area of a web page) in which advertisements can be presented.

To facilitate searching of these resources, the environment 100 can include a search system 112 that identifies the resources by crawling and indexing the resources provided by the publishers on websites. Information/data about the resources can be indexed based on the resource to which the information/data corresponds. The indexed and, optionally, cached copies of the resources are stored in a search index 115. In some implementations, the search system 112 may be for searching resources hosted by a specific publisher. For example, a search system 112 for an audio/visual publisher, such as YouTube, Vimeo, Hulu, Twitch, DailyMotion, and/or the like, may have a dedicated search system for resources hosted on servers belonging to the audio/visual publisher. Such search systems may crawl and index resources hosted by servers belonging to the publisher. Similarly, a search system 112 for an informational publisher, such as Wikipedia, may have a dedicated search system for resources hosted on servers belonging to the informational publisher.

In some implementations, user devices 106 and 106′ receive and store global positioning system (GPS) data. For example, user devices 106 and 106′ may receive information/data from one or more satellites to enable the user devices to determine their current location and/or orientation. This information/data may be stored in association with time stamps. The stored information/data may be used to determine the location of user devices 106 and 106′ at a time a specific action was performed. For example, the GPS information/data on a user device 106 may be used to determine the location of the user device 106 when customized gaming content was generated by the user device 106.

Advertisement schedule tracking system 110 is responsible for collecting and storing advertisement schedule information/data for advertisements during live television broadcasts. For example, the advertisement schedule tracking system 110 may determine in real-time that a commercial break has begun during live television broadcasting of a specific show on a particular channel. In response, the advertisement schedule tracking system 110 may provide to one or more user devices 106 a signal indicative of the commercial break starting/beginning. In some implementations, the signal may be provided to a third party server. Similarly, the advertisement schedule tracking system 110 may determine in real-time that a commercial break ended during a live television broadcast of a specific show on a particular channel (e.g., The Blacklist on NBC). In response, the advertisement schedule tracking system 110 may provide to one or more user devices 106 a signal indicative of the commercial break finishing/ending. In some implementations, the determinations and signaling is performed in real-time based on live detection of the commercial breaks beginning/beginning and finishing/ending. In some implementations, the advertisement schedule tracking system 110 receives information/data specifying the timing of commercial breaks from a corresponding channel, prior to the live broadcasting. In some implementations, the advertisement schedule tracking system and/or user devices 106 may predict the beginning and end of a commercial break based on historical information/data associated with the broadcasting channel.

In one implementation, once an area (e.g., gaming area) has been defined or identified, one or more geofences may be defined for the area, such as a geofence around the area. The geofences may be defined to surround a defined area, such as surrounding countries, regions, states, counties, cities, towns, interstates, roads, streets, avenues, zip codes, area codes, neighborhoods, establishments (e.g., restaurants, bars, houses), and/or the like. The geofences may be defined, for example, by the latitude and longitude coordinates associated with various points along the perimeter of the area. Alternatively, geofences may be defined based on latitude and longitude coordinates of the center, as well as the radius of the area. Geofences may be as large as an entire country, region, state, county, city, or town (or larger). Similarly, geofences may be as small as an apartment, room, or shed (or smaller). The areas, and therefore the geofences, may be any shape including, but not limited to, a circle, square, rectangle, an irregular shape, and/or the like. Moreover, the geofenced areas need not be the same shape or size. Accordingly, any combination of shapes and sizes may be used in accordance with implementations of the present invention.

Similarly, a geofence may overlap or reside wholly within another geofence. For example, a geofence of an area or town, for instance, may have geofences defined around private land areas (e.g., parking lots of malls), off-road areas, and/or establishments.

In one implementation, once at least one geofence has been defined, the coordinates (or similar methods for defining the geofenced areas) may be stored in an information/database. Thus, as user devices 106 enters and exits the one or more defined geofences, a computing entity, such as host device 106′, can monitor the location of the user devices 106 and trigger/initiate certain events based on the user devices locations.

In one implementation, after the one or more geofenced areas (e.g., geofences) have been defined, the location of user devices 106 can be monitored. Generally, the location of user devices 106 can be monitored by any of a variety of computing entities. For example, as noted above, user devices 106 location at a particular time may be determined using stored GPS information/data 114. By using user devices 106 location, a computing entity can determine, for example, when a user device 106 enters or leaves a defined geofence.

In one implementation, after a user device106 has entered the geofenced area, the location of the user device 106 can continue to be monitored by any of a variety of computing entities. By using the user device 106 location, a computing entity can determine, for example, when the user device 106 exits the defined geofenced area. As described, this may include using location-determining devices, or other telemetry location services (e.g., cellular assisted GPS or real time location system or server technology using received signal strength indicators from a Wi-Fi network). The following examples are provided in the context of a single or multiplayer trivia game, but certainly apply to a variety of other applications.

### III. Geofences for Location-Based Control

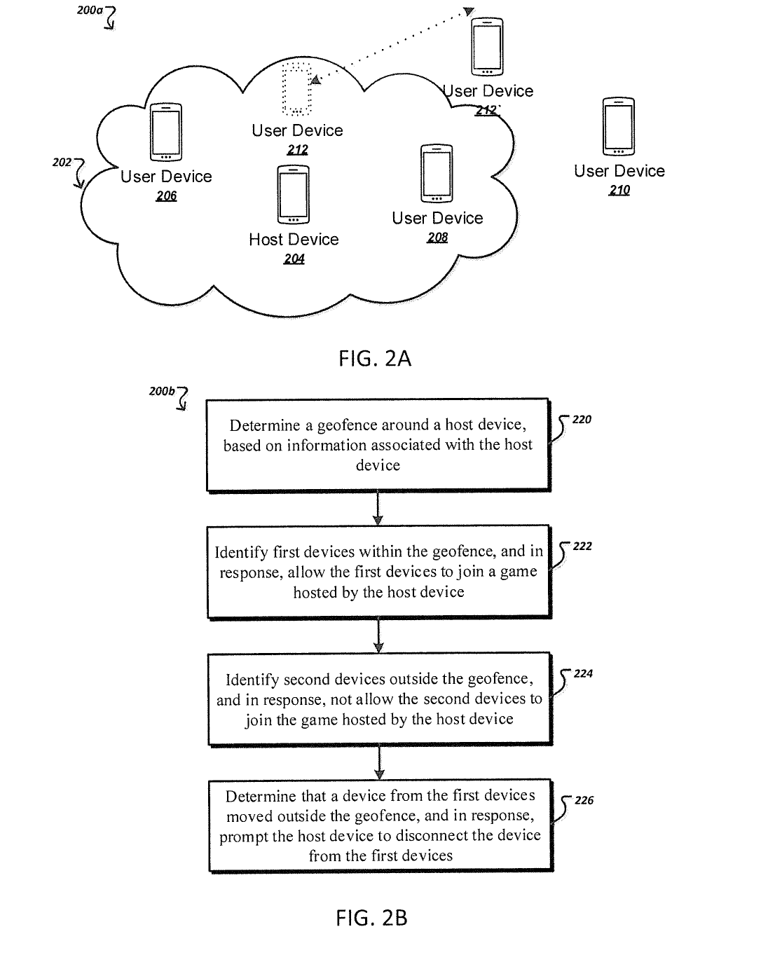

In one embodiment, a multiplayer trivia game may begin with the identification of the players or participants for the game. For instance, FIG. 2A is an example environment 200a in which a multiplayer game is hosted by a user device having a customizable geofence 202. In some implementations, the host device 204 can define a customizable geofence 202 around the host device 204. In other implementations, the geofence 202 is pre-defined geofence around a particular establishment. In yet other implementations, the geofence 202 is a pre-defined geofence surrounding host device 204.

In some implementations, host device 204 may host a live multiplayer game. User devices within the geofence 202 surrounding user device 204 are allowed to join the live multiplayer game. For example, user devices 206 and 208 are allowed to join the game. On the other hand, user devices that are outside the geofence 202 are not allowed to join the live multiplayer game. For example, user device 210 may not be allowed to join the live multiplayer game. In some implementations, the live multiplayer game is a trivia game hosted by host device 204.

In some implementations, user device 204 controls and moderates the live trivia game. A user device may be removed from a live game, for example, cheating or being idle for a period of time. For example, the host device can remove a user device, such as 208, from the game after the device 208 joins the game for one of the above reasons. In some implementations, the host device 204 is presented with a different interface for moderating the game. As user devices move within (and outside of) the geofence, different notifications may be presented to the host device. This will be discussed in more detail with reference to FIG. 2B below. The moderating interface may include other customization options for hosting the game. For example, a host may set a maximum number of players that can join the game or manually remove or suspend a particular user device from the game.

FIG. 2B is a flow chart of an example process 200b for hosting a multiplayer game having a customizable geofence. The process 200b begins with determining a geofence around a host device based on information/data associated with the host device (220). The information/data may be GPS information, preference information/data and/or information/data defining parameters of the geofence. The geofence may be defined by the user device to contain an establishment or a portion of an establishment where the live trivia game is hosted. In some implementations, the geofence actively surround host device 204. For example, within a particular establishment the host device may move from a first room to a second room within the establishment. Accordingly, a geofence surrounding host device 204 may, before the host device 204 movement, contain only the first room and in response to the host device 204 movement the geofence may contain only the second room. This, for example, enables a host device 204 to move the trivia game from a first room within a restaurant to a second room within the restaurant. As described above, in some implementations, the geofence 202 is stationary.

The process 200b continues by identifying first devices within the geofence, and in response allow the first device to join a game hosted by the host device (222). For example, devices 206, 208 and 212 (shown in phantom) are within geofence 202. Therefore, devices 206, 208 and 212 may join the live trivia game. Similarly, the process 200b identifies second devices outside the geofence and in response, not allow the second devices to join the game hosted by the host device (224). For example, device 210 is outside geofence 202 and is accordingly not allowed to join the live trivia game. In some implementations, user devices outside the geofence are allowed to join a particular live trivia game by manually providing a unique code for the game. The code may be made available to the hosting device in response to hosting a live trivia game.

Finally, the process 200b determines that a device from the first devices moved outside the geofence, and in response prompt the host device to disconnect the device from the first devices (226). With reference FIG. 2A, elements 212 (shown in phantom) and 212′ respectively show a starting position and a final position of user device 212. In some implementations, as the user device 212 moves from the beginning position 212 to the final position 212′, it may be determined that the user device 212 exited the geofence. In turn, the host device 204 receives an indication that the user device 212 exited the geofence. In some implementations, the indication may further include an interface element and message prompting the user to select either removing device 212 from the live game or allowing device 212 to remain in the game. In some implementations, the message and the interface element are provided as push notifications. In other implementations, the message and the interface element are provided as a text message. In some implementations, the message and the interface element are provided using the interface of the multiplayer game.

The host device 204 may be presented with an interface that allows the user to keep track of individual or team scores. In some implementations, the host interface may include options to allow the host to send messages or push notifications to user devices that joined a game hosted by the host. The host device 204 interface may also allow the host to declare an individual or a group game winner. In some implementations, prizes for winners may be distributed electronically through the user interface. In some implementations, performance rankings for individuals or groups may be displayed to the individuals, the groups, all game members, and/or all users within a particular geofence. In some implementation, a cumulative score for an individual or a group may be maintained during a pre-specified period. In some implementations, an individual or a group may use their points accrued during a game, a set of games, or all games played to redeem one or more prizes. Different prizes may require a different amount of accrued points to redeem. For example, a movie ticket voucher may be redeemed for 10 points, while a flat panel television set may be redeemed for 1500 points. In some implementations, prizes provided by establishments hosting a multiplayer game may be redeemed only by participants within geofence 202. For example, in response to detecting that a user, within the geofence 202, is attempting to redeem a prize using their points, the user may be allowed to redeem the prize. Alternatively, in response to detecting that a user, outside the geofence 202, is attempting to redeem a prize using their points, the user may not be allowed to redeem the prize. As will be recognized, a variety of other techniques and approaches can be used to provide location-based controls for such games.

### IV. Video Looping of Customized Audio/Visual Content

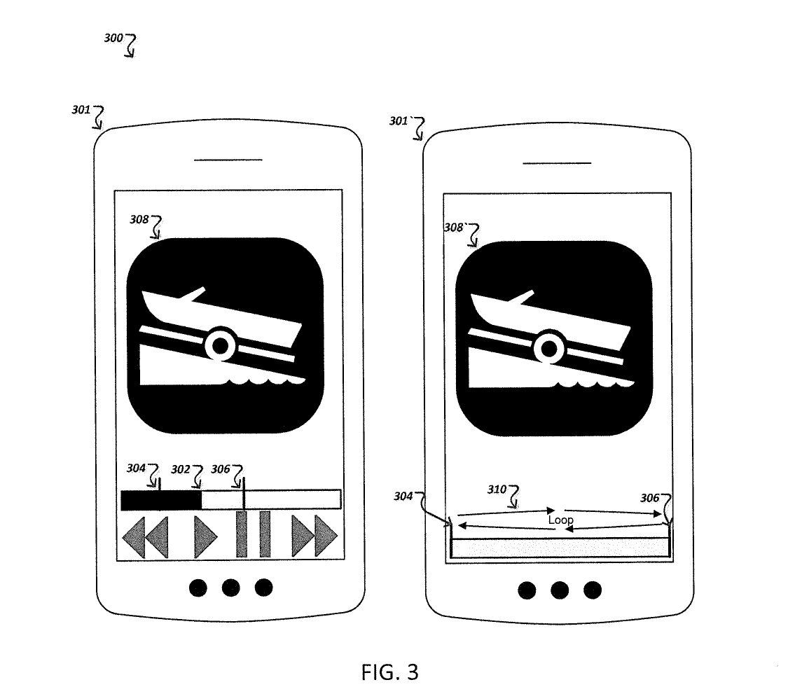

In one embodiment, video looping can be used for questions, stumps, and/or the like as part of a trivia game or question answering session. For instance, FIG. 3 depicts a mobile device using video looping stream to generate customized gaming content for an online adaptive multiplayer game. A mobile device 301 may be used to access audio/visual content, such as video stream 308, hosted by an audio/visual provider or publisher. The stream may be used to generate customized gaming content for an online adaptive multiplayer game. For example, the video may be used to generate custom content for a trivia game. A mobile device user may choose a specific portion of the video stream to pair with a customized trivia question. For example, the mobile device user may generate a question inquiring as to whether the boat in video 308 is moving upward or downwards. Alternatively, the trivia question may ask users to determine which movie a video clip is from.

The mobile device 301 may access video stream 308 in order to generate customized gaming content. The video stream 308 may be displayed in a video player on the mobile device 301. In some implementations, the video player is part of an interface for a multiplayer game. The video player may include playback controls 309. The playback controls enable, for example, rewinding, pausing and fast-forwarding of the video 308. A cursor 302 (or other indicator) indicates a current time of the video 308 relative to the entire length of the video. For example, cursor 302 may indicate that the video 308 is currently playing is at the 1 minute and 42 seconds mark and that entire video is 5 minutes long.

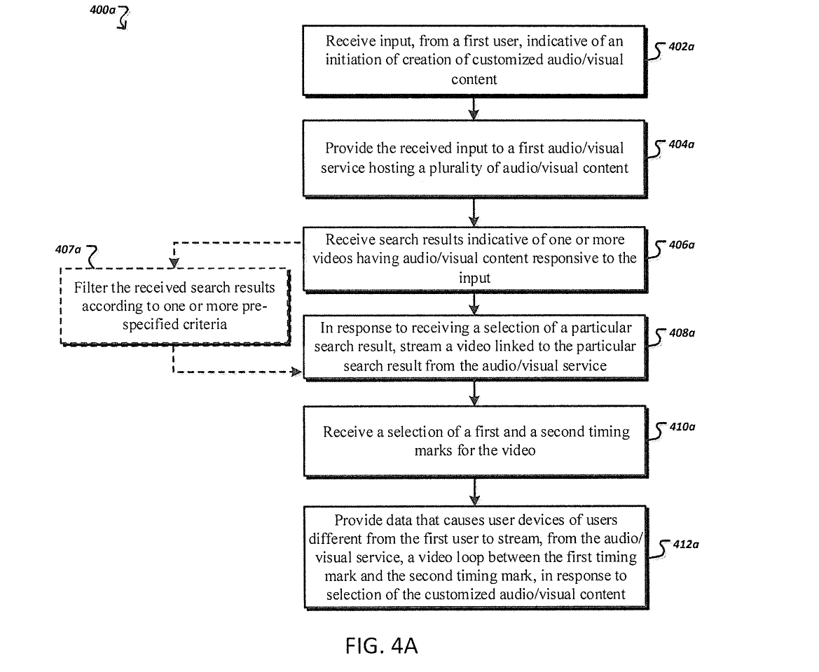

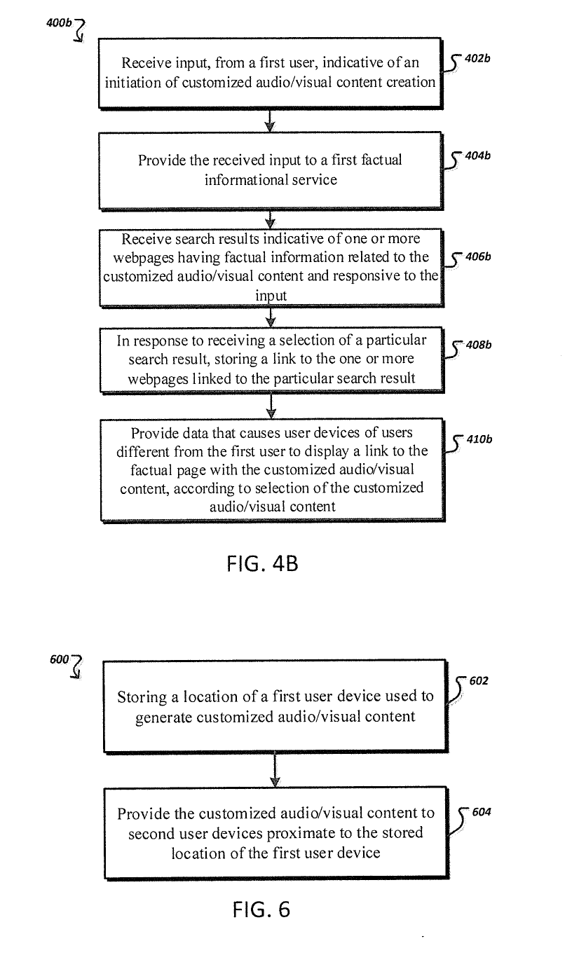

A mobile device 301 user may select a loop starting mark 304. The loop starting mark 304 defines a beginning of loop 310 of a portion of video 308. Similarly, a user may select a loop ending mark 306. The loop ending mark 308 defines an end of loop 310 of a portion of video 308. The loop 310 is a video loop between mark 304 and mark 306. In some implementations, the video loop between marks 304 and 306 is repeated for a particular number of times. For example, the loop may be repeated for 10 times before pausing or stopping the video. The above enables mobile device users to select any portion of a video stream for custom loop creation. In some implementations, the generation of custom video loops 310 from streams do not require download of the video 308 from which the custom loop 310 is created. In some implementations, users accessing the custom content may directly stream the loop 310 without downloading video 308 from which the custom loop 310 was generated. The creation of customized audio/visual content is discussed in more detail below with reference to FIG. 4A.

FIG. 4A is a flow chart of an example process 400a for generating customized audio/visual gaming content for an online adaptive multiplayer game. The process 400a begins with receiving input, from a first user, indicative of an initiation of creation of customized audio/visual content (402a). For example, a user may interact with a user interface element to initiate the creation of customized content. In some implementations, the first user may provide a query as input indicative of the initiation above. In some implementations, the query may be a text query. In some implementations, the query may be an audio/visual query. For example, the query may be an image query. In some implementations, the query may be query for resources associated with the customized content the user is creating. For example, a user creating a customized trivia question related to a “Star Wars” movie may provide “Star Wars,” “Han Solo,” or “Harrison Ford” as a text query. Alternatively, the user may provide an image or a video of “Han Solo” as an audio visual query.

The process 400a then provides the received input to a first audio/visual service hosting a plurality of audio/visual content (404a). For example, the process 400a may provide the query “Han Solo” to an audio/visual service hosting a plurality of audio/visual content, such as YouTube. In some implementations, the audio/visual service and content are published by a publisher different from the publisher of the multiplayer game. In turn, the process 400a receives search results indicative of one or more videos having audio/visual content responsive to the input (406a). For example, videos or links associated with videos responsive to the query “Han Solo” may be received in response to the provided query. An audio/visual service may be, for example, a dedicated webpage or group of webpages having a plurality of audio/visual resources. In some implementations, an audio/visual service may host the audio/visual resources above as well as the webpages on servers belonging to the audio/visual service.

Filtering step 407a shown in phantom is an optional step of process 400a. In some implementations, step 407a is not a part of the process 400a. In other implementations, the process 400a continues by filtering the received search results according to one or more pre-specified criteria (407a). For example, the process 400a may filter the received search results videos responsive to “Han Solo” to determine which videos can be embedded within the user interface of the multiplayer game. In some implementations, videos that cannot be embedded within the user interface are removed from the search results.

The search results or a proper sub group of the search results may be provided to a user device of the first user for display. In response to receiving a selection of a particular search result, the process 400a streams a video linked to the particular search result from the audio/visual service (408a). In some implementations, the video streaming and presentation occurs within the interface of the multiplayer game. For example, once a user selects a video responsive to the query “Han Solo,” the associated video is streamed within the interface of the multiplayer game.

The process 400a continues by receiving a selection of a first and a second timing marks for the video (410a). For example, the user may select a first and a second timing mark using the interface of the multiplayer game. The first and second timing marks define a beginning and end of a video loop between the first and second marks. For example, as described with respect to FIG. 3, the user may select timing marks 304 and 306 to define a loop 310 between the timing marks 304 and 306. The loop 310 may be the portion of video 308 that is most suitable for display with a customized trivia question.

Finally, the process 400a ends with providing information/data that causes user devices of users different from the first user to stream, from the audio/visual service, a video loop between the first timing mark and the second timing mark, in response to selection of the customized audio/visual content (412a). For example, a second user may select a trivia question generated using the customized audio/visual content created by the first user. In response to the selection, the video loop 310 from the video responsive to “Han Solo” may be displayed on a user device of the second user within the multiplayer game interface. In some implementations, the loop 310 is displayed concurrently with a trivia question. In some implementations, the loop 310 is displayed prior to or after display of a trivia question. In some implementations, the loop 310 is streamed directly from the audio/visual provider without downloading the video or the loop to the user device of the second user.

In some implementations, the video looping and process 400a may be used for advertisements. For example, the customized audio/visual content may be created for an advertisement by a user. The customized audio/visual content may be displayed within, for example, a user interface, an html element, an Iframe, or a text message.

FIG. 4B is a flow chart of an example process 400b for generating customized factual validation gaming content for an online adaptive multiplayer game. Similar to step 402a of process 400a, process 400b begins with receiving input, from a first user, indicative of an initiation of customized audio/visual content creation (402b). For example, a user may interact with a user interface element to initiate the creation of customized content. In some implementations, the first user may provide a query as input indicative of the initiation above.

In some implementations, a single query may initiate both processes 400a and 400b simultaneously. For example, a user creating a customized trivia question including customized audio visual content may provide a single query, such as “Han Solo,” using the interface for the trivia game and simultaneously initiate both process 400a and process 400b simultaneously.

The process 400b continues with providing the received input to a first factual informational service (404b). For example, a user creating customized audio/visual content responsive to “Han Solo” may provide “Han Solo” as query to a first factual informational service, such as Wikipedia. A factual informational service may be, for example, a dedicated webpage or group of webpages having factual information. In some implementations, a factual informational service may host said webpages on servers belonging to the factual informational service. In some implementations, the publisher of the factual information/data service and webpages is different from the publisher of the multiplayer game and different from the publisher of the audio/visual service and content.

In turn, the process 400b receives search results indicative of one or more webpages having factual information/data related to the customized audio/visual content and responsive to the input (406b). For example, webpages or links associated with webpages responsive to the query “Han Solo” may be received in response to the provided query. The webpages searched may be limited to particular publishers that publish factual information. For example, the webpages searched may be limited to webpages hosted by publishers of encyclopedias or domain names associated with particular encyclopedia websites. In some implementations, the search results may be filtered according to pre-specified criteria. For example, the results may be filtered to remove pages that have inaccurate factual information. In some implementations, the search results are displayed on a user device of the first user.

Process 400b continues by storing a link to the one or more webpages linked to the particular search result, in response to receiving a selection of a particular search result (408b). For example, a user may select a Wikipedia page related to “Star Wars” where a section of the webpage includes information/data regarding “Han Solo.” A link or a uniform resource locater (URL) associated with the selected webpage is stored. In some implementations, the user interface may allow the user to highlight or mark certain portions of the webpage. These highlights or marking may be stored in association with the link as an overlay.

Finally, the process 400b ends by providing information/data that causes user devices of users different form the first user to display a link to the factual webpage with customized audio/visual content, according to selection of the customized audio/visual content (410b). For example, when a second user different from the first user selects the customized audio/visual trivia question created by the first user and associated with “Han Solo,” the process 400b provides a link to the “Star Wars” Wikipedia page above to the second user's user device. In some implementations, the link is only provided in response to the second user answering the trivia question. In some implementations, the link is intended to provide validation or proof that the provided answer for the custom generated trivia question is correct. In some implementations, the user interface includes interface elements that allow users to report incorrect answers. In some implementations, the user interface includes interface elements that upon user interaction redirect user devices to the selected webpage having the supplied URL or link.

As described above processes 400a and 400b may be initiated simultaneously. Other steps of each process may also be carried out simultaneously or may be variously combined. For example, steps 412a and 410b may also be performed simultaneously. For example, when a second user selects a customized audio/visual trivia question, the second user may receive information/data that causes the user device of the second user to stream video loop 310 and display the link to the factual webpage.

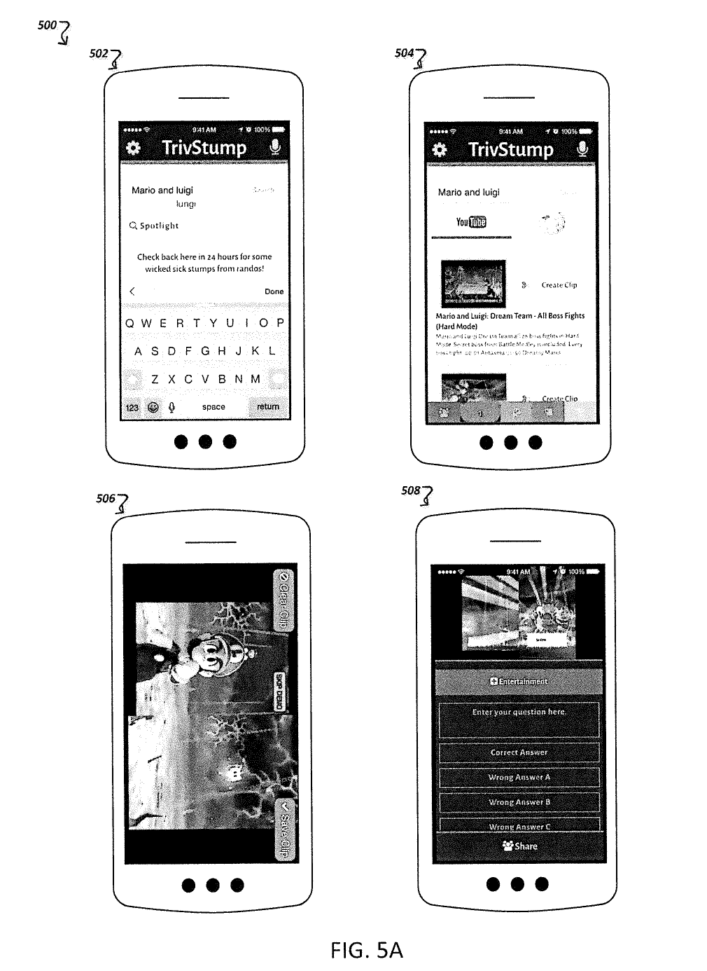

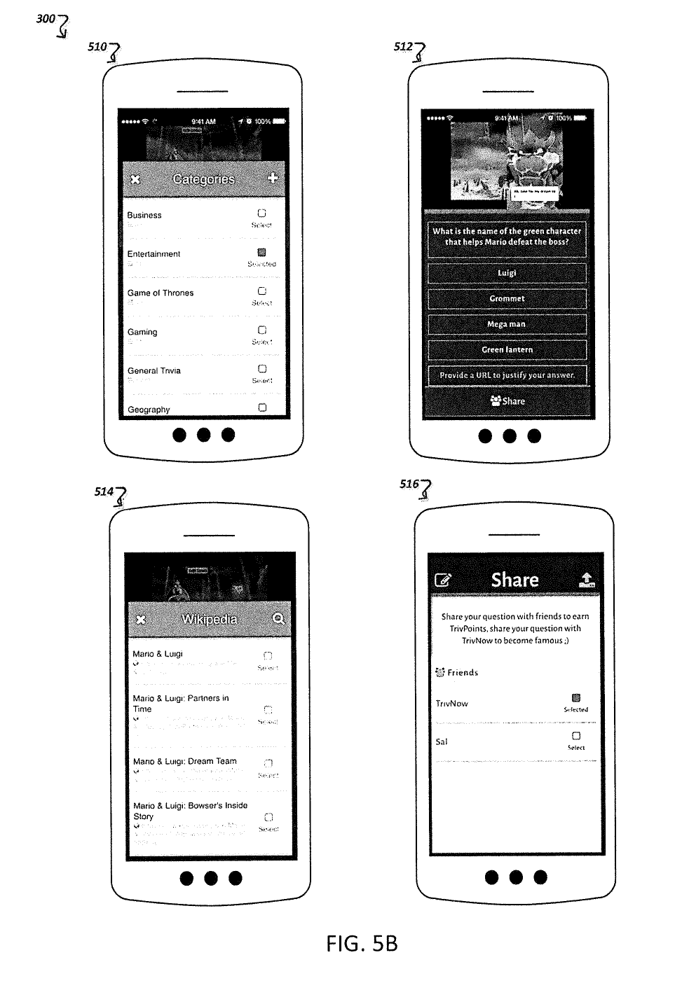

In some implementations, a user creating the customized audio/visual content may be prompted to enter a question and a plurality of answers for association with the customized content, as discussed in more detail below with reference to FIG. 5. For example, a user may be required to input a question, a correct answer, and 3 incorrect answers. These may be displayed to other users accessing the customized audio/visual content along with the customized audio/visual content. In some implementations, when a different user selects the correct answer, a push notification is sent to the customized audio/visual content creator specifying that a user provided a correct answer. Similarly, in some implementations, when a different user selects an incorrect answer, a push notification is sent to the customized audio/visual content creator specifying that a user provided an incorrect answer. In some implementations, the customized audio/visual content creator is awarded points for each user that provides an incorrect answer in response to accessing the customized audio/visual content.

FIG. 5A and FIG. 5B depict a mobile device using an interface for an online adaptive multiplayer game. The environment 500, depicts an example user interface for a mobile user device performing steps of process 400a and process 400b. For example, a user may provide an input “Mario and Lugi” to a user interface for a trivia game 502. In some implementation, the user is provided with auto-completion suggestions as the user provides the text. In response to the input, the user interface provides the user with videos, from a third party publisher, responsive to the input. For example, the user interface may display videos or links to videos, hosted by YouTube, that are responsive to “Mario and Lugi” 504. The user may select a video from the displayed videos. For example, the user may select the video titled “Mario and Lugi: Dream team . . . ” 504. In response to the selection, the interface displays a stream of the selected video 506. The user may customize the audio visual content to create a video loop as described above with reference to FIGS. 3 and 4A.

Upon completion, the user is prompted to select a category for the custom trivia question 508. For example, the user may select the “gaming” or “entertainment” category for the “Mario and Lugi” question 510. The user may also be prompted to select, a question, a correct answer and one or more incorrect answers for presentation with video as the custom trivia question 508. For example, the user may provide a question stating “what is the name of the green character that helps Mario defeat the boss?” 512. The user may also provide a correct answer and 4 incorrect answers. For example, the user may provide “Lugi” as the correct answer and “Gommet,” “Mega Man,” and “Green Lantern” as the incorrect answers 512.

The user may also be prompted to provide a URL that justifies the provided correct answer. The user interface may display a list of factual webpages that are responsive to the provided input. For example, the user interface may display Wikipedia webpages responsive to “Mario and Lugi” 514. The user can select a webpage from the displayed webpages, such that a URL for the selected webpage is provided with the custom trivia question. For example, the user may select the Mario and Lugi Wikipedia page for display with the custom trivia question. Finally, the user may be prompted to select other users or friends for sharing the custom question. For example, the user may share the custom trivia question with all the adaptive online game users 516. Alternatively, the user may select to share the custom question with one or more friends of the user.

In turn, the users that are selected at the sharing step above receive the custom trivia question. When a user interacts with the shared question, the user interface displays the customized video loop, the customized question, and the customized answers above to the user. In some implementations, the customized video loop is streamed to the user device. In some implementations, the customized video loop is not downloaded to the user device. A user may then select an answer, and is notified whether the selected answer is correct. In some implementations, the user interface provides the validation URL to the user in response to receiving an answer.

In some implementations, users that receive a customized trivia question are prompted to rate the question. For example, users may provide “like” or “dislike” rating to the custom question. In some implementations, if a custom question receives a number of likes above a particular threshold, the question is added to a general pool of question. This may allow the question to be provided as standard question to users across different types of game modes. In some implementations, a ratio of likes to dislikes may be used as the threshold. For example, custom questions that receive twice as many likes as dislikes may be added to the general pool of questions. As will be recognized, a variety of other approaches and techniques can be used to adapt to various needs and circumstances.

### V. Providing Localized Content for Users

In one embodiment, questions, stumps, video loops, and/or the like can be localized to the location of the users. For example, FIG. 6 is a flow chart of an example process for distributing customized audio/visual content for an online adaptive multiplayer game. In one embodiment, the process 600 can being with storing a location of a first user device used to generate customized audio/visual content (602). In other embodiments, this step can occur after the content is created. For example, GPS information/data 114 associated with the first user device may be stored during custom audio/visual content creation. The GPS information/data 115 may specify the location of the first user device during the audio/visual content creation. In other words, each audio/visual content created, can be stored in association with location information/data for the corresponding creator. The audio/visual content can then be provided to users in the same or similar location as the creator. For instance, being in the same location may be the same geographic area, such as the same region, state, province, country, city, town, postal code, and/or the like. Similarly, being in a similar location may be a similar demographic area, climatic area, interest area, and/or the like.

In turn, process 600 provides the customized audio/visual content to second user devices proximate to the stored location of the first user device (604). For example, the customized content may be provided to user devices within a geographical location including the stored location. In other implementations, the customized content may be provided to user devices within a geographical location proximate or adjacent to the stored location. The geographical location may be a city or a state. For example, a custom question created in the state Georgia may be served to other users within the state of Georgia. Similarly, a custom question created in the city of Chicago may be served to user devices within the city of Chicago. As described above, the geographical locations can be defined using geofences. In some implementations, the custom content is provided to user devices within a pre-specified radius from the stored location. For example, a custom question may be shared with user devices within a 30 mile radius of the user device. In some implementations, the user may manually select other user accounts to share the customized content with.

In some implementations, the geographical location proximate to or including the stored location where user devices receive the customized question, may be differently defined based on the category to which the question belongs. For example, customized sports or food questions may be shared with user devices within a smaller geographical area. Similarly, customized entertainment or automobile questions may be shared with a larger geographical area. For example, customized sports questions may be shared with a city or a state containing the stored location. A sports question may be, for example, regarding a local sport team. Users outside the corresponding city or state to which the sports team belongs may be unfamiliar with the sports team. Accordingly, the geographical area for sharing questions categorized as sports questions may be more conservative. Alternatively, entertainment questions are more universal. For example, a customized question regarding the movie “Star Wars” may be shared with an entire country or even continent. Familiarity with movies can, for example, be independent of regions. Accordingly, the geographical area for sharing questions categorized as entertainment questions may be less conservative than sports questions.

VI. Gaming Synchronization with Commercial Breaks

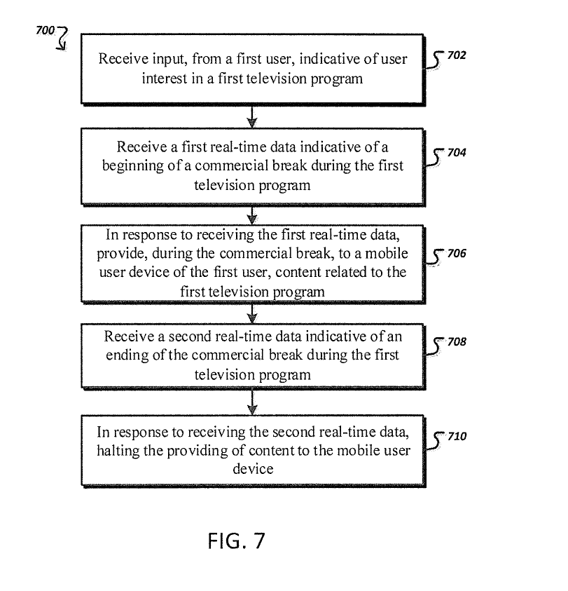

In some implementations, games may be synchronized with a live or recorded broadcast (e.g., cable, satellite, Internet, and/or the like programming). For example, FIG. 7 is a flow chart of an example process for providing gaming content to user devices during commercial breaks based on real-time data. The process 700 begins with receiving input, from a first user, indicative of user interest in a first television program (702). For example, the user may subscribe to a “Walking Dead” group using the interface for the trivia game. In turn, the process 700 continues by receiving a first real-time information/data indicative of a beginning of a commercial break during the first television program (704). For example, a signal specifying that a commercial break started during live television broadcasting of the “Walking Dead” may be received. A commercial break may be one or more commercials interposed between portions of the live television programming.

In response to receiving the first real-time data, the process 700 provides, during the commercial break, to a mobile user device of the first user, content related to the first television program (706). For example, in response to receiving the signal specifying that a commercial break started during live television broadcasting of the “Walking Dead,” the mobile device of the first user may begin to provide trivia questions related to the “Walking Dead.” In some implementations, the mobile device of the first user may begin to provide general trivia questions, in response to receiving the signal above. In some implementations, the mobile device of the first user may begin to provide trivia questions associated with the genre of the television show. For example, the trivia game may provide questions related to the “Horror” genre during the commercial break.

The process 700 continues by receiving a second real-time information/data indicative of an ending of the commercial break during the first television program (708). For example, a second signal specifying that the commercial break ended during the live television broadcasting of the “Walking Dead” may be received. In response to receiving the second real-time data, the process 700 halts the providing of the content to the mobile user device. For example, in response to receiving the signal specifying that a commercial break started during live television broadcasting of the “Walking Dead,” the mobile device of the first user may stop the providing of trivia questions related to the “Walking Dead.”

In some implementations, the process 700 is performed for a plurality of users simultaneously. For example, a plurality of users that are all subscribed to the “Walking Dead” group may receive identical trivia questions during the commercial break. In some implementations, the plurality of users compete to achieve a highest score during the commercial break. In some implementations, a multi-player competitive game may span more than one commercial break. For example, the plurality of users may compete in a cumulative game during all commercial breaks within an episode or multiple episodes of the “Walking Dead.”

In some implementations, users receive push notifications indicating that competitive game begun. Users may also unsubscribe from groups that the users previously subscribed to. For example, a user may unsubscribe to the “Walking Dead” group. In turn, that user will no longer receive trivia questions or game push notifications during commercial breaks within that television program.

In some implementations, one or more user may join a game lobby to play a competitive online game. For example, 4 users may join a lobby to start a trivia game. In some implementations, a server provides questions to the users at a specific timer interval. In other implementations, a node interposed between the user devices and the server is responsible for requesting questions from the server according pre-specified conditions. For example, the node may request a new question in response to determining that a current question has been answered by all 4 users. Alternatively, the node may terminate the game or halt requests for new questions, in response to determining that all 4 users left the lobby. In some implementations, the node periodically monitors the user devices to determine if the pre-specified conditions are met. In some implementations, the node periodically requests or fetches information/data from the user devices to determine if the pre-specified conditions are met. As will be recognized, a variety of other approaches can techniques can be used to adapt to various needs and circumstances.

### VII. Exemplary Computer Systems, Entities, Devices

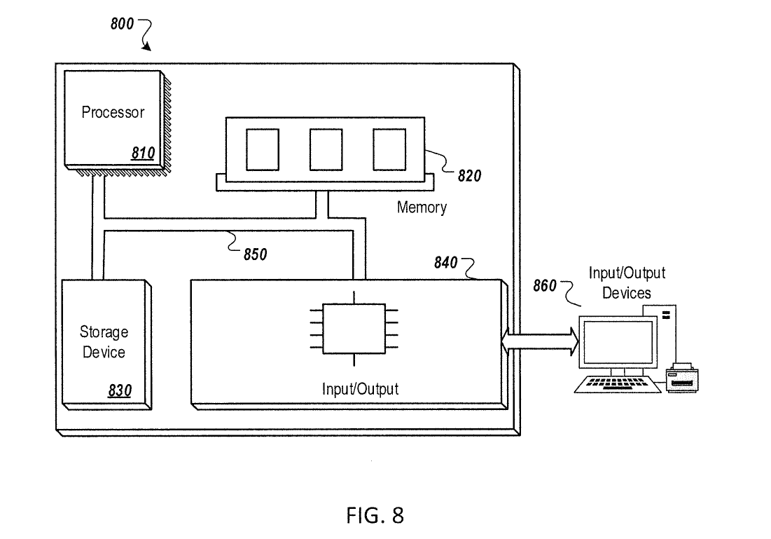

FIG. 8 is block diagram of an example computer system that can be used to create and/or distribute customized audio/visual content and/or other aspects of the invention. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information/data within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can include, for example, a hard disk device, an optical disk device, or some other large capacity storage device.

The input/output device 840 provides input/output operations for the system 800. In one implementation, the input/output device 840 can include one or more network interface devices, e.g., an Ethernet card, a serial communication device, e.g., an RS-232 port, and/or a wireless interface device, e.g., an 802.11 card. In another implementation, the input/output device can include driver devices configured to receive input information/data and send output information/data to other input/output devices, e.g., keyboard, printer and display devices 860. Other implementations, however, can also be used, such as mobile computing devices, mobile communication devices, set-top box television client devices, etc.

In general, the terms, computer system, computing entity, processor, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the system 800 may include one or more input/output device for communicating with various computing entities, such as by communicating data, content, information, and/or similar terms used herein interchangeably that can be transmitted, received, operated on, processed, displayed, stored, and/or the like. For instance, the system 800 may communicate with user devices 106 and/or a variety of other computing entities.

As shown in FIG. 8, in one embodiment, the system 800 may include or be in communication with one or more processor 810 (also referred to as processing element, processing circuitry, and/or similar terms used herein interchangeably) that communicate with other elements within the system 800 via a bus 850, for example. As will be understood, the processor 810 may be embodied in a number of different ways. For example, the processor 810 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor may be configured for a particular use or configured to execute instructions stored in volatile or non-volatile media or otherwise accessible to the processor 810. As such, whether configured by hardware or computer program products, or by a combination thereof, the processor 810 may be capable of performing steps or operations according to embodiments of the present invention when configured accordingly.

In one embodiment, the system 800 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity—relationship model, object model, document model, semantic model, graph model, and/or the like.

In one embodiment, the system 800 may further include or be in communication with volatile media (also referred to as volatile storage, memory, memory storage, memory circuitry and/or similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 810. Thus, the databases, database instances, database management systems, data, applications, programs, program modules, scripts, source code, object code, byte code, compiled code, interpreted code, machine code, executable instructions, and/or the like may be used to control certain aspects of the operation of the system 800 with the assistance of the processor 810 and operating system.

As indicated, in one embodiment, the management system 800 may also include one or more input/output interface for communicating with various computing entities, such as by communicating data, content, information, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the system 800 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

The system 800 may include or be in communication with one or more input devices 860, such as a keyboard input, a mouse input, a touch screen/display input, motion input, movement input, audio input, pointing device input, joystick input, keypad input, and/or the like. The system 800 may also include or be in communication with one or more output devices 860, such as audio output, video output, screen/display output, motion output, movement output, and/or the like.

As will be appreciated, one or more of the system 800 components may be located remotely from other system 800 components, such as in a distributed system. Furthermore, one or more of the components may be combined and additional components performing functions described herein may be included in the system 800. Thus, the system 800 can be adapted to accommodate a variety of needs and circumstances. As will be recognized, these architectures and descriptions are provided for exemplary purposes only and are not limiting to the various embodiments.

### VIII. Example User Device

A user may be an individual, a family, a company, an organization, an entity, a department within an organization, a representative of an organization and/or person, and/or the like. To do so, a user may operate a user device 106 that includes one or more components that are functionally similar to those of the system 800. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User devices 106 can be operated by various parties. User devices 106 can include an antenna, a transmitter (e.g., radio), a receiver (e.g., radio), and a processing element (e.g., CPLDs, microprocessors, multi-core processors, coprocessing entities, ASIPs, microcontrollers, and/or controllers) that provides signals to and receives signals from the transmitter and receiver, respectively.

The signals provided to and received from the transmitter and the receiver, respectively, may include signaling information/data in accordance with air interface standards of applicable wireless systems. In this regard, the user device 106 may be capable of operating with one or more air interface standards, communication protocols, modulation types, and access types. More particularly, the user device 106 may operate in accordance with any of a number of wireless communication standards and protocols, such as those described above with regard to the system 800. In a particular embodiment, the user device 106 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user device 106 may operate in accordance with multiple wired communication standards and protocols, such as those described above with regard to the system 800 via a network interface.

Via these communication standards and protocols, the user device 106 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user device 106 can also download changes, add-ons, and updates, for instance, to its firmware, software (e.g., including executable instructions, applications, program modules), and operating system.

According to one embodiment, the user device 106 may include location determining aspects, devices, modules, functionalities, and/or similar words used herein interchangeably. For example, the user device 106 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data can be determined by triangulating the user device 106 position in connection with a variety of other systems, including cellular towers, Wi-Fi access points, and/or the like. Similarly, the user device 106 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user device 106 may also comprise a user interface (that can include a display coupled to a processing element) and/or a user input interface (coupled to a processing element). For example, the user interface may be a user application, browser, user interface, and/or similar words used herein interchangeably executing on and/or accessible via the user device 106 to interact with and/or cause display of information/data from the system 800, as described herein. The user input interface can comprise any of a number of devices or interfaces allowing the user device 106 to receive data, such as a keypad (hard or soft), a touch display, voice/speech or motion interfaces, or other input device. In embodiments including a keypad, the keypad can include (or cause display of) the conventional numeric (0-9) and related keys (#, *), and other keys used for operating the user device 106 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user device 106 can also include volatile storage or memory and/or non-volatile storage or memory, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user device 106. As indicated, this may include a user application that is resident on the entity or accessible through a browser or other user interface for communicating with the system 800 and/or various other computing entities.

In another embodiment, the user device 106 may include one or more components or functionality that are the same or similar to those of the system 800, as described in greater detail above. As will be recognized, these architectures and descriptions are provided for exemplary purposes only and are not limiting to the various embodiments.

### IX. Additional Implementation Details

Although an example processing system has been described in FIG. 8, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively or in addition, the program instructions can be encoded on an artificially-generated propagated signal, e.g., a machine-generated electrical, optical, or electromagnetic signal, that is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for creating and distributing customized audio/visual content comprising:
receiving input, from a first user, indicative of an initiation of customized audio/visual content creation;
in response to receiving a selection of a particular search result, stream a video linked to the particular search result from an audio/visual service hosting a plurality of audio/visual content;
receiving a selection of a first timing mark and a second timing mark for the video; and
providing information/data that causes user devices of users different from the first user to stream, from the audio/visual service, a video loop of the video between the first timing mark and the second timing mark, in response to selection of the customized audio/visual content.

2. The method of claim 1, further comprising:
providing the received input to the audio/visual service;
receiving search results indicative of one or more videos having audio/visual content responsive to the received input.

3. The method of claim 1, wherein the customized audio/visual content is content of a user created trivia question.

4. The method of claim 1, further comprising filtering the received search results according to one or more pre-specified criteria.

5. The method of claim 3, wherein the pre-specified criteria comprise removing videos that cannot be embedded in a display of a mobile device from the search results.

6. The method of claim 1, further comprising providing the received input to a second audio/visual service.

7. The method of claim 1, further comprising:
providing the received input to a first factual informational service;
receiving search results indicative of one or more webpages having factual information/data related to the customized audio/visual content and responsive to the received input; and
in response to receiving a selection of a particular search result, storing a link to a one or more webpages linked to the particular search result.

8. The method of claim 6, further comprising:
providing information/data that causes user devices of users different from the first user to display a link to the factual webpage with the customized audio/visual content, in response to selection of the customized audio/visual content.

9. The method of claim 1 further comprising:
storing a location of a first user device used to generate the customized audio/visual content; and
providing the customized audio/visual content to second user devices proximate to the stored location of the first user device.

10. The method of claim 8, wherein a pre-specified threshold is used to determine that a second user device is proximate to the stored location of the first user device.

11. A method comprising:
receiving input, from a first user, indicative of user interest in a first television program;
receiving a first real-time information/data indicative of a beginning of a commercial break during the first television program; and
in response to receiving the first real-time data, providing during the commercial break, to a mobile user device of the first user, content related to the first television program.

12. The method of claim 10 further comprising:
receiving a second real-time information/data indicative of an ending of the commercial break during the first television program; and
in response to receiving the second real-time data, halting the providing of content to the mobile user device.

13. A method for hosting a live game session comprising:
determining a geofence around a host device, based on information/data associated with the host device;
identifying first devices within the geofence, and in response, allow the first devices to join a game hosted by the host device;
identifying second devices outside the geofence, and in response not allow the second devices to join the game hosted by the host device; and
determining that a device from the first devices moved outside the geofence, and in response, prompt the host device to disconnect the device from the first devices.

14. The method of claim 12, wherein the information/data associated with host device comprises user input information/data specifying parameters defining the geofence.

15. The method of claim 13, wherein the parameters define a size and a shape of the geofence.

16. The method of claim 13, wherein the geofence moves in response to movements of the host device.

17. The method of claim 13, wherein the host device provide information/data that alters one or more configurations of the game, comprising:
changing score multipliers for one or more users;
change a category of questions type;
change a timer for questions.

18. A non-transitory computer-readable medium having computer-executable instructions stored thereon that, when executed by a computing device, cause the computing device to perform operations comprising:
receiving input, from a first user, indicative of an initiation of customized audio/visual content creation;
in response to receiving a selection of a particular search result, stream a video linked to the particular search result from an audio/visual service hosting a plurality of audio/visual content;
receiving a selection of a first timing mark and a second timing mark for the video; and
providing information/data that causes user devices of users different from the first user to stream, from the audio/visual service, a video loop of the video between the first timing mark and the second timing mark, in response to selection of the customized audio/visual content.

19. A non-transitory computer-readable medium having computer-executable instructions stored thereon that, when executed by a computing device, cause the computing device to perform operations comprising:
receiving input, from a first user, indicative of user interest in a first television program;
receiving a first real-time information/data indicative of a beginning of a commercial break during the first television program; and
in response to receiving the first real-time data, providing during the commercial break, to a mobile user device of the first user, content related to the first television program.

20. A non-transitory computer-readable medium having computer-executable instructions stored thereon that, when executed by a computing device, cause the computing device to perform a method for hosting a live game session comprising:
determining a geofence around a host device, based on information/data associated with the host device;
identifying first devices within the geofence, and in response, allow the first devices to join a game hosted by the host device;
identifying second devices outside the geofence, and in response not allow the second devices to join the game hosted by the host device; and
determining that a device from the first devices moved outside the geofence, and in response, prompt the host device to disconnect the device from the first devices.
second timing mark, in response to selection of the customized audio/visual content.
